(19) United States
(12) Patent Application Publication
(10) Pub. No.: US 2007/0181383 A1
(43) Pub. Date: Aug. 9, 2007

(54) Elevator cab and construction method thereof

(76) Inventor: Agnaldo Bizarria Santos, Sao Paulo (BR)

Correspondence Address: SCHWEITZER CORNMAN GROSS & BONDELL LLP, 292 MADISON AVENUE - 19th FLOOR, NEW YORK, NY, 10017, US

(21) Appl. No.: 11/642,004

(22) Filed: Dec. 18, 2006

(30) Foreign Application Priority Data
Dec. 20, 2005 (EP) 05112524.3

(51) Int. Cl. B66B 11/02

(52) U.S. Cl. 187/401

(57) ABSTRACT

The present invention provides an elevator cab comprising at least one wall formed from two or more panels, each panel having a front surface forming an interior surface of the elevator cab, a female connector and a male connector attached to opposing edges of the front surface, respectively. The male connector includes a projection which is parallel to but transversely displaced from the front surface and the female connector defines a slot which is parallel to, but transversely and laterally displaced from, the front surface. The slot has an opening facing towards the front surface. The projection of one wall panel is laterally inserted through the opening and into the slot of a neighbouring panel and a securing element is transversely inserted between the two wall panels.

The present invention relates to elevators and, in particular, to an elevator cab and a construction method thereof.

### BACKGROUND OF THE INVENTION

Conventional elevator cabs or cars generally comprise neighbouring panels that are connected together using conventional fasteners such as nuts and bolts to form the side walls. To ensure that the fasteners are not visible from within the finished elevator cab, the fasteners are normally located on the outside of the cab. Such a system is described and shown in DE-C1-4446023. Accordingly, a large amount of the assembly has to be carried out in the relatively small space between the cab and the hoistway wall which can be frustrating, difficult and time consuming.

A solution to this problem is disclosed in U.S. Pat. No. 6,082,501 whereby a first panel is initially secured by a floor bracket to the cab platform so that the panel is aligned along a side edge of the platform. The panel has a hook portion which extends in towards the cab. A second panel having a J-shaped latch member extending out towards the hoistway is then maneuvered into position such that the J-shaped latch member can be inserted into the hook portion of the first panel. In this position the second panel extends at an angle greater than 75° to the side edge of the platform and therefore the majority of the second panel projects from the platform into the hoistway. Accordingly, the clearance between the platform and the hoistway walls must be sufficient to accommodate the second panel in this position. Once the latch member has been inserted into the hook portion, the second panel is rotated into the desired position on the platform and secured by a floor bracket to the platform.

The continual pressure on the elevator industry to maximize space efficiency has resulted in that the designer can no longer afford the clearance between the platform and the hoistway walls required to accommodate the second panel in a 75°, pre-rotation position.

An alternative solution is discussed in U.S. Pat. No. 5,842,545 wherein the side walls comprise a plurality of wall panels each having at least one longitudinal edge interlocking with a longitudinal edge of an adjacent wall panel to connect the wall panels together without any additional fasteners. Each interlocking longitudinal edge has a C- or G-shaped cross sectional flange with cutaway areas defining a plurality of alternating locking members and slots. The. locking members of a wall panel flange are insertable through slots of an adjacent wall panel flange and longitudinally moveable relative thereto to engage the locking members of the two wall panel flanges to connect the wall panels together. Accordingly, during assembly a wall panel must be lifted vertically so that its locking members are horizontally aligned to the slots in the adjacent wall panel. Then it is moved horizontally to insert the locking members through the slots in the adjacent wall panel. Finally, it must be lowered so that the locking members engage with the locking members of the adjacent wall panel.

Although this solution certainly avoids the major problem associated with U.S. Pat. No. 6,082,501 in that the assembly of the cab can be confined substantially within the area of the platform, it requires a large amount of manual dexterity and strength on the part of the technician. From the dimensions quoted in U.S. Pat. No. 5,842,545, each of wall panels could weight up to 90 kg, making it extremely difficult for the technician to manually raise each wall panel, hold it in the elevated position so as to align it with the neighbouring panel and insert it through the slots of the neighbouring panel, and finally to lower it so that it engages with the neighbouring panel and rests on the platform.

A further problem associated with the prior art elevator cabs discussed above is that during construction each wall panel must be effectively locked or secured in position (either to the platform in U.S. Pat. No. 6,082,501, or to a neighbouring panel in U.S. Pat. No. 5,842,545) before subsequent panels may be added in the same manner to form an entire side wall of the cab. Any misalignment of the panels in these construction methods has a cumulative effect and there is no tolerance in these systems to make any final adjustments after the wall has been constructed to rectify the misalignments.

Accordingly the objective of the present invention is to provide a panel assembly, an elevator cab assembly and a construction method thereof wherein the assembly of the cab is confined substantially within the area of the platform and can be realized without lifting one panel relative to a neighbouring wall panel.

### BRIEF DESCRIPTION OF THE INVENTION

This objective is achieved by providing an elevator cab comprising at least one wall formed from two or more panels, each panel having a front surface forming an interior surface of the elevator cab, a female connector and a male connector attached to opposing edges of the front surface respectively, wherein the female connector defines a slot which is parallel to but transversely and laterally displaced from the front surface, and the male connector includes a projection which is parallel to but transversely displaced from the front surface. The slot has an opening facing towards the rear of the front surface, the projection of one panel is inserted through the opening and into the slot of a neighbouring panel and a securing element is inserted between the neighbouring panels.

Accordingly, the projection of one panel is sandwiched within the slot from the neighbouring panel, preventing relative transverse movement therebetween. The subsequent insertion from the front of the securing element between the neighbouring wall panels securely seats the projection within the slot and thereby prevents relative lateral movement therebetween. Hence, the neighbouring walls panels are effectively locked together.

The panels can be interconnected from the front and therefore installed from the elevator cab platform. The wall panels are interconnect primarily through lateral displacement rather than transverse displacement, therefore the clearance between the platform and the hoistway walls can be reduced to the minimum.

Preferably, the front surface may comprise two perpendicular surfaces which meet at a corner. A panel having this configuration can be used as a corner panel to interconnect panels from mutually perpendicular walls.

Preferably, the neighbouring panels forming the walls are initially interconnected through engagement of the male and female connectors as previously described to prevent relative transverse movement. When the entire cab wall has been thus formed, final adjustments can be made to the individual panels before the securing elements are inserted between the panels to securely lock the panels together.

### BRIEF DESCRIPTION OF THE DRAWINGS

The present invention is hereinafter described by way of specific examples with reference to the accompanying drawings in which:

FIG. 1 is cross-section of a wall panel according to the present invention;

FIGS. 2A to 2D illustrate the sequence in which the wall panel of FIG. 1 is attached to an identical neighbouring wall panel to construct a portion of a wall of an elevator cab;

FIG. 3 illustrates a corner panel interconnecting two wall panels according to FIG. 1 which form a portion of two mutually perpendicular elevator cab walls;

FIG. 4 is a section of an insert according an embodiment of the invention; and

FIG. 5 is an exploded perspective view of an elevator cab incorporating wall formed from the wall panels of FIGS. 1 to 3.

### DETAILED DESCRIPTION OF THE INVENTION

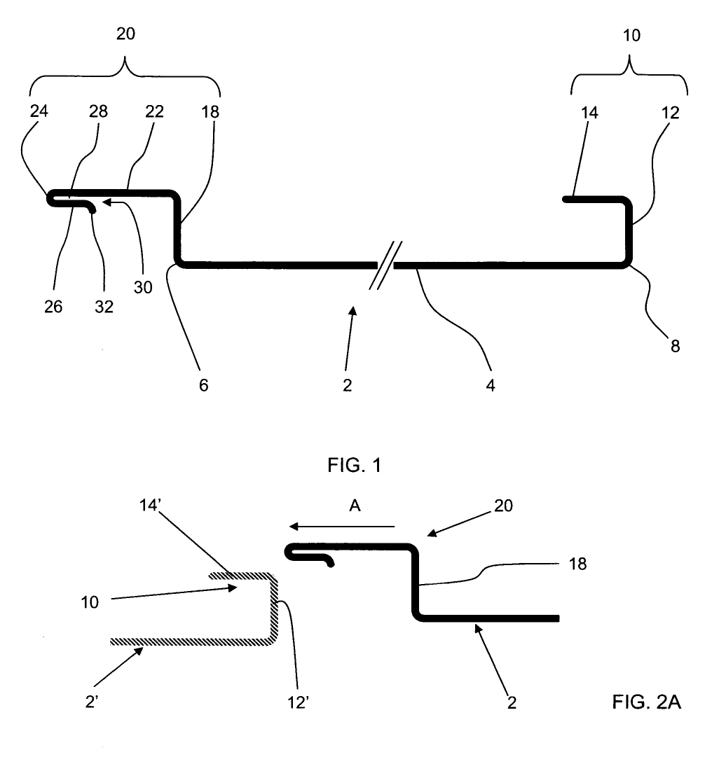

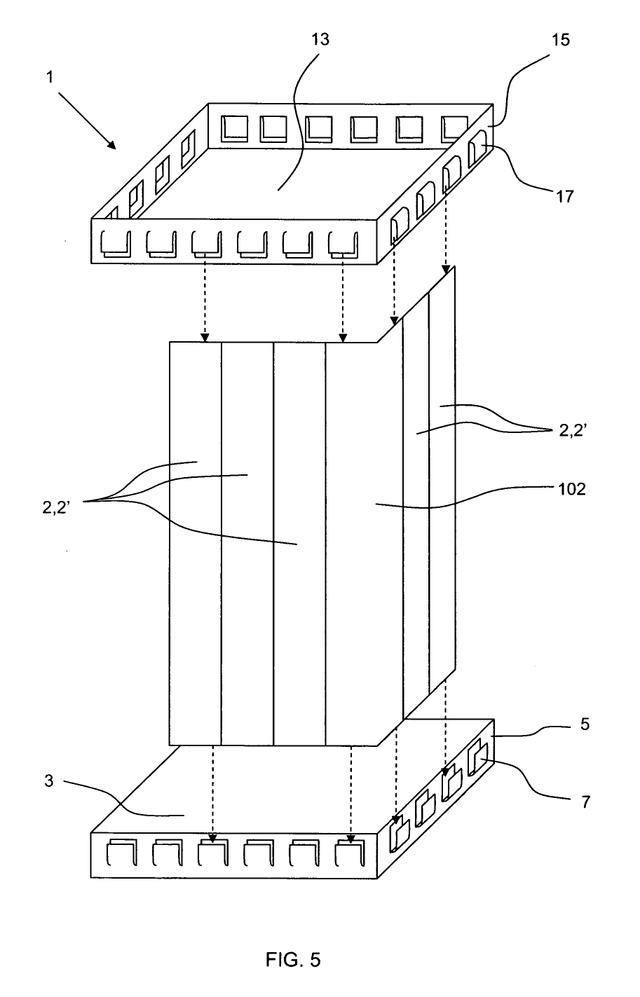

FIG. 1 shows a cross-section of a wall panel 2 according to the present invention. The wall panel 2 is connected to identical wall panels 2 to form a side wall of an elevator cab 1 (as shown in FIG. 5). Each wall panel 2 comprises a front planar surface 4 which eventually forms a part of the interior surface of the elevator cab 1. A female connector 20 is provided at a first longitudinal edge 6 of the front surface 4. Similarly, a male connector 10 is provided at a second longitudinal edge 8 of the front surface 4.

The female connector 20 comprises a first leg portion 18 attached at one end to the first longitudinal edge 6 of the front surface 4 and projecting perpendicularly backwards therefrom, and attached at the other end to a J-shaped profile extending parallel to but recessed from the front surface 4. The J-shaped profile has a first member 22 and a web member 24 interconnecting the first member 22 with a second member 26. The second member 26 is disposed parallel to and in front of the first member 22. Furthermore, the second member 26 is shorter than the first member 22. Accordingly, a slot 28 is defined by the first member 22, the web member 24 and the second member 26 of the female connector 20. The slot 28 has an opening 30 that faces towards the first leg portion 18. Preferably, the free end of the second member 26 has a lip 32.

The male connector 10 comprises a second leg portion 12 attached at one end to a second longitudinal edge 8 of the front surface 4 and projecting perpendicularly backwards therefrom, and attached at the other end to a projection 14 extending parallel to and behind the front surface 4.

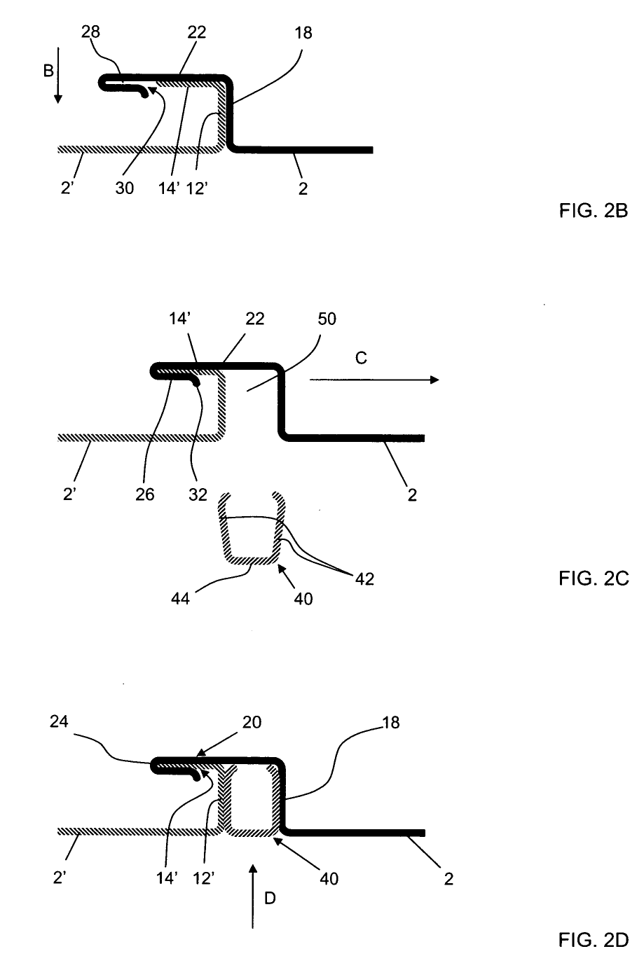

FIGS. 2A to 2D show the sequence in which two identical wall panels 2, 2′ are secured together to construct a portion of wall of the elevator cab 1. Although both panels 2, 2′ are identical, for the purpose of clarity, a prime (′) has been used in the reference numerals to distinguish features of the left panel 2′, referred to hereinafter as the second or neighbouring panel, from those of the right panel 2 referred to hereinafter as the first panel. Furthermore, only the male connector 10′ side of the second panel 2′ and only the female connector 20 side of the first panel 2 are shown in the Figures.

As shown in FIG. 2A, the first panel 2 is moved laterally in the direction A towards the second panel 2′. During this relative movement, the female connector 20 passes behind the male connector 10′ of the neighbouring panel 2′. After the second member 26 and lip 32 of the female connector 20 have cleared past the projection 14′ of the male connector 10′, the panels 2, 2′ can be brought transversely together as depicted by the arrow B in FIG. 2B so that the first member 22 of the female connector 20 is in abutment with the projection 14′ of the male connector 10′ of the neighbouring panel 2′. The panels 2, 2′ are then laterally separated from each other as depicted by the arrow C in FIG. 2C. During this relative movement, the lip 32 helps to guide the projection 14′ through the opening 30 and into the slot 28 of the female connector 20. In this position, the projection 14′ is securely sandwiched between the first member 22 and the second member 26 of the female connector 20, thereby preventing relative transverse movement between the panels 2, 2′.

A generally U-shaped longitudinal insert 40 is provided, having opposing sides 42 which spread backwards and outwards from an intermediate connecting portion 44. As shown in FIG. 2D, the insert 40 is pushed in a transverse direction D into the cavity 50 defined at one side by the first leg portion 18 of the female connector 20, at the rear by the first member 22 of the female connector 20, and at the other side by the second leg portion 12′ of the male connector 10′. During this motion, the opposing sides 46 are elastically deformed to provide reactional forces against the first leg portion 18 of the first panel 2 and the second leg portion 12′ of the second panel 2′. These reactional forces bias the two panels 2, 2′ away from each other, which consequently ensures that the projection 14′ of the male connector 10′ is securely seated against the web portion 24 of the female connector 20 and that relative lateral movement between the panels 2,2′ is prevented.

Accordingly, the sandwiching of the projection 14′ of the male connector 10′ between the first and second members of the female connector 20 prevents relative transverse movement between the panels 2,2′ and the reactional forces exerted by the insert 40 on the panels 2, 2′ prevents relative lateral between the panels 2,2′. Therefore, all horizontal relative movement of the panels 4'4′ is essentially prohibited and the two panels 2, 2′ are effectively locked together.

Two or more panels 2 are fixed together in this manner to form a wall of the elevator cab 1.

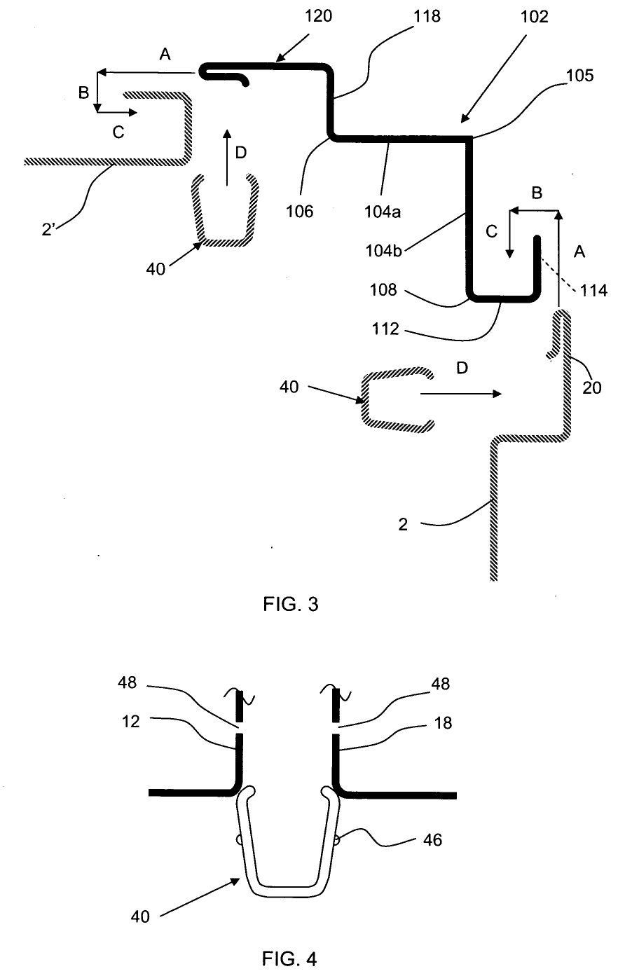

FIG. 3 shows a cross-section of a corner panel 102 interconnecting two wall panels 2, 2′ which form a portion of two mutually perpendicular elevator cab walls. The corner panel 102 is essentially identical to the wall panel 2 of FIG. 2 except it comprises two perpendicular front surfaces 104a and 104b which meet at a corner 105. A female connector 120 is attached to and projects perpendicularly backwards and outwards from a first longitudinal edge 106 on the first front surface 104a. A male connector 110 is mounted to and projects perpendicularly backwards from a second longitudinal edge 108 on the second front surface 104b.

The method of locking the panels together is exactly the same as previously described and is shown diagrammatically in FIG. 3 by the arrows A to D. In a first step A, the female connector of one of the panels is moved laterally behind the male connector of the neighbouring panel. In step B, the neighbouring panels are brought transversely together as so that the first member of the female connector is in abutment with the male connector of the neighbouring panel. Then in step C the panels are laterally separated from each other. Finally, in step D the insert 40 is transversely inserted between the first leg portion of one panel and the second leg portion of the neighbouring panel.

In the above description, the term lateral means aligned to the plane defined by the associated cab wall and the term transverse means perpendicular to the plane defined by the associated cab wall.

FIG. 4 illustrates in greater detail an insert 40 according one embodiment of the invention. Projections 46 are provided on the opposing sides 42 to engage with corresponding holes 48 provided in the first leg portion 18 and second leg portion 10 of the panels 2.

FIG. 5 is an exploded perspective view showing an elevator cab 1 according to the present invention. On the installation site, a platform 3 is the first component of the cab 1 which is brought into the elevator hoistway. The platform 3, which acts as the floor of the cab 1, is generally the main load-bearing component of the cab 1 and is normally supported on a car frame for movement within the elevator hoistway. In the present embodiment, the platform 3 is manufactured from a single sheet of metal which has its edges turned down through an angle of 90° to form side walls 5. A plurality of brackets 7 are stamped from the side walls 5 to create U-shaped channels along the periphery of the platform 3.

The cab walls are then constructed by inserting the wall panels 2, 2′ into the U-shaped channels on the platform 3. Preferably the neighbouring panels 2, 2′ forming the walls are initially interconnected through engagement of the male and female connectors as previously described to prevent relative transverse movement. When the entire cab wall has been thus formed, final adjustments can be made to the individual panels 2, 2′ before the inserts 40 are pushed into the cavities 50 to securely lock the panels together.

Next a drop ceiling 13 can be brought into the cab 1 and lowered onto the panels 2, 2′. The drop ceiling 13 is essentially an inverted version of the platform 3. In the present embodiment, the ceiling 13 is manufactured from a single sheet of metal which has its edges turned up through an angle of 900 to form side walls 15. A plurality of brackets 17 are stamped from the side walls 5 to create inverted U-shaped channels along the periphery of the ceiling 3 to receive the panels 2, 2′.

I claim:

1. An elevator cab, comprising at least one wall formed from two or more panels, each panel having a front surface forming an interior surface of the elevator cab, a female connector and a male connector attached to opposing edges of the front surface respectively, wherein the male connector includes a projection which is parallel to but transversely displaced from the front surface,
characterized in that the female connector defines a slot which is parallel to but transversely and laterally displaced from the front surface and has an opening facing towards a rear of the front surface,
the projection of one panel is insertable through the opening and into the slot of a neighbouring panel, and
a securing element is insertable between the one and neighbouring panels.

2. The elevator cab according to claim 1, wherein the front surface of at least one panel comprises two perpendicular surfaces which meet at a corner.

3. The elevator cab according to claim 1 or 2, wherein the securing element is resilient.

4. The elevator cab according to claim 1 or 2, wherein the securing element has at least two projections for engaging with corresponding holes provided in the one and neighbouring panels.

5. The elevator cab according to claim 1 or 2 further comprising a platform having U-channels at edges thereof for receiving the panels.

6. The elevator cab according to claim 1 or 2 further comprising a ceiling having inverted U-channels at edges thereof for receiving the panels.

7. A method for constructing an elevator cab, comprising the steps of:
providing two or more panels, each panel having a front surface forming an interior surface of the elevator cab, a female connector and a male connector attached to opposing edges of the front surface, respectively, wherein the male connector includes a projection which is parallel to but transversely displaced from the front surface;
providing the female connector with a slot which is parallel to but transversely and laterally displaced from the front surface and having an opening (30) facing towards the rear of the front surface;
inserting the projection of one wall panel through the opening and into the slot of a neighbouring panel to prevent relative transverse movement therebetween, and
inserting a securing element between the one and neighbouring panels to prevent relative lateral movement therebetween.

8. The method according to claim further comprising the step of making final positional adjustments to the individual panels before the securing elements are inserted between the panels.

9. The method according to claim 7 or 8 further comprising the steps of providing a platform having U-channels at edges thereof and inserting the panels into the channels.

10. The method according to claim 7 or 8 further comprising the steps of providing a ceiling having inverted U-channels at edges thereof and inserting the panels into the channels.

11. An elevator cab wall panel assembly, comprising:
first and second panels, each panel having a front surface forming an interior surface of the elevator cab, a female connector and a male connector attached to opposing edges of the front surface respectively, wherein the male connector includes a projection which is parallel to but transversely displaced from the front surface, the female connector having a slot which is parallel to but transversely and laterally displaced from the front surface and has an opening facing towards a rear of the front surface,
the projection of the male connector of the first panel being dimensioned and constructed to be insertable through the opening and into the slot of the female connector of the second panel, and
a securing element insertable between the first and second panels.

12. The panel assembly of claim 11, wherein the securing element has opposed sides for applying an outwardly directed retaining force against adjacent male and female connectors of the first and second panels.

13. The panel assembly of claim 11, wherein the front surface of the first panel comprises two perpendicular surfaces which meet at a corner.

14. The panel assembly of claim 11 or 12, wherein the securing element is resilient.

15. The panel assembly of claim 11 or 12, wherein the securing element has at least two projections for engaging with corresponding holes provided in the first and second panels.
